(19) United States
(12) Patent Application Publication
(10) Pub. No.: US 2024/0236677 A1
(43) Pub. Date: Jul. 11, 2024

(54) METHODS, SYSTEMS, AND COMPUTER READABLE MEDIA FOR ROUTING MESSAGES BETWEEN PUBLIC LAND MOBILE NETWORKS

(71) Applicant: Oracle International Corporation, Redwood Shores, CA (US)

(72) Inventors: Jay Rajput, Bangalore (IN); Virendra Singh, Bangalore (IN); John Nirmal Mohan Raj, Bangalore (IN)

(21) Appl. No.: 18/096,007

(22) Filed: Jan. 11, 2023

(51) Int. Cl. H04W 12/08; H04L 9/40

(52) U.S. Cl. CPC H04W 12/08; H04L 63/0281

(57) ABSTRACT

A method for providing a security edge protection proxy (SEPP) router for routing messages between roaming hub SEPPs includes registering, at an SEPP router, a first roaming hub SEPP. Registering the first roaming hub SEPP includes receiving an NFRegister request from the first roaming hub SEPP, the NFRegister request including an NF profile of the first roaming hub SEPP, and storing, by the SEPP router, at least a portion of the NF profile of the first roaming hub SEPP. The method further includes receiving, at the SEPP router, a service-based interface (SBI) request message from a second roaming hub SEPP, and determining, by the SEPP router, a public land mobile network (PLMN) as an intended destination for the SBI request message. The method further includes routing, by the SEPP router, the SBI request message to the first roaming hub SEPP.

### TECHNICAL FIELD

The subject matter described herein relates to routing messages between public land mobile networks (PLMNs). More particularly, the subject matter described herein relates to providing a security edge protection proxy (SEPP) router for routing messages between SEPPs.

### BACKGROUND

In 5G telecommunications networks, a network function that provides service is referred to as a producer NF or NF service producer. A network function that consumes services is referred to as a consumer NF or NF service consumer. A network function can be a producer NF, a consumer NF, or both, depending on whether the network function is consuming, producing, or consuming and producing services. The terms “producer NF” and “NF service producer” are used interchangeably herein. Similarly, the terms “consumer NF” and “NF service consumer” are used interchangeably herein.

A given producer NF may have many service endpoints, where a service endpoint is the point of contact for one or more NF instances hosted by the producer NF. The service endpoint is identified by a combination of Internet protocol (IP) address and port number or a fully qualified domain name (FQDN) that resolves to an IP address and port number on a network node that hosts a producer NF. An NF instance is an instance of a producer NF that provides a service. A given producer NF may include more than one NF instance. It should also be noted that multiple NF instances can share the same service endpoint.

NFs register with a network function repository function (NRF). The NRF maintains profiles of available NF instances identifying the services supported by each NF instance. The profile of an NF instance is referred to in 3GPP TS 29.510 as an NF profile. NF instances can obtain information about other NF instances that have registered with the NRF through the NF discovery service operation. According to the NF discovery service operation, a consumer NF sends an NF discovery request to the NRF. The NF discovery request includes query parameters that the NRF uses to locate the NF profiles of producer NFs capable of providing the service identified by the query parameters. NF profiles are data structures that define the type of service provided by an NF instance as well as contact and capacity information regarding the NF instance.

A service communication proxy (SCP) can also invoke the NF discovery service operation to learn about available producer NF instances. The case where the SCP uses the NF discovery service operation to obtain information about producer NF instances on behalf of consumer NFs is referred to as delegated discovery. Consumer NFs connect to the SCP, and the SCP load balances traffic among producer NF service instances that provide the required services or directly routes the traffic to the destination producer NF instances.

In addition to the SCP, another example of an intermediate proxy that forwards traffic between producer and consumer NFs is the security edge protection proxy (SEPP). The SEPP is the network function used to protect control plane traffic that is exchanged between different 5G public land mobile networks (PLMNs). As such, the SEPP performs message filtering, policing and topology hiding for all application programming interface (API) messages that are transmitted between PLMNs. A roaming hub with roaming hub SEPPs may be implemented to route messages between SEPPs of different PLMNs.

One problem in 5G and other types of networks is that as more SEPPs are deployed for scalability and/or security, each SEPP requires more complex routing features to route messages between consumer SEPPs and producer SEPPs. It would be desirable to find a mechanism to eliminate the need for each SEPP to feature such complex routing features. However, 3GPP standards do not define an SEPP router or how an SEPP router would operate in a roaming hub.

Accordingly, there exists a need for improved methods, systems, and computer readable media for securing band routing messages between networks.

### SUMMARY

A method for providing a security edge protection proxy (SEPP) router for routing messages between roaming hub SEPPs includes registering, at an SEPP router, a first roaming hub SEPP. Registering the first roaming hub SEPP includes receiving, at the SEPP router, an NFRegister request from the first roaming hub SEPP, the NFRegister request including an NF profile of the first roaming hub SEPP. Registering the first roaming hub SEPP further includes storing, by the SEPP router, at least a portion of the NF profile of the first roaming hub SEPP. The method further includes receiving, at the SEPP router, a service-based interface (SBI) request message from a second roaming hub SEPP, and determining, by the SEPP router and using the stored at least a portion of the NF profile of the first roaming hub SEPP, a PLMN as an intended destination for the SBI request message. The method further includes routing, by the SEPP router, the SBI request message to the first roaming hub SEPP based on the stored at least a portion of the NF profile of the first roaming hub SEPP and the determination of the PLMN as the intended destination for the SBI request message.

In some embodiments, registering the first roaming SEPP includes receiving and processing the NFRegister request via an NFRegister interface implemented at the SEPP router.

In some embodiments, storing the at least a portion of the NF profile includes storing the at least a portion of the NF profile in an SEPP registration database at the SEPP router.

According to another aspect of the subject matter described herein, the method may further include receiving, at the SEPP router, a plurality of SBI request messages from a plurality of roaming hub SEPPs, and filtering, using a security database in the SEPP router, the plurality of SBI request messages.

The method may include prioritizing, by the SEPP router, traffic among roaming hub SEPPs.

In some embodiments, the method includes receiving, at a configuration interface of the SEPP router, user input for registering roaming hub SEPPs.

According to another aspect of the subject matter described herein, the method may further include performing, by the SEPP router, load balancing among roaming hub SEPPs.

The method may include applying a security measure to the SBI request message. In some embodiments, the security measure applied includes network topology hiding.

According to another aspect of the subject matter described herein, a system for routing messages between PLMNs includes an SEPP router including at least one processor for routing messages among roaming hub SEPPs, and an SEPP registration manager implemented by the at least one processor for registering, at the SEPP router, a first roaming hub SEPP. Registering the first roaming hub SEPP includes receiving, at the SEPP router, an NFRegister request from the first roaming hub SEPP, the NFRegister including an NF profile of the first roaming hub SEPP, and storing, by the SEPP router, at least a portion of the NF profile of the first roaming hub SEPP. The system further includes an inter-PLMN routing manager implemented by the at least one processor for receiving an SBI request message from a second roaming hub SEPP, determining, by the SEPP router, a PLMN as an intended destination for the SBI request message, and routing, by the SEPP router, the SBI request message to the first roaming hub SEPP based on the stored at least a portion of the NF profile of the first roaming hub SEPP and the determination of the PLMN as the intended destination for the SBI request message.

In some embodiments of the system, storing the at least a portion of the NF profile includes storing the at least a portion of the NF profile in an SEPP registration database at the SEPP router.

According to another aspect of the subject matter described herein, the SEPP router is configured for receiving a plurality of SBI request messages from a plurality of roaming hub SEPPs, and filtering, using a security database in the SEPP router, the plurality of SBI request messages.

The system may include an SEPP router configured for prioritizing traffic among roaming hub SEPPs.

In some embodiments, the SEPP router may be configured for receiving, at a configuration interface of the SEPP router, user input for registering roaming hub SEPPs.

According to another aspect of the subject matter described herein, the SEPP router is configured for performing load balancing among roaming hub SEPPs.

The SEPP router may be configured for applying a security measure to the SBI request message. In some embodiments, the security measure applied includes network topology hiding.

According to another aspect of the subject matter described herein, a non-transitory computer readable medium having stored thereon executable instructions that when executed by at least one processor of at least one computer cause the at least one computer to perform steps. The steps are performed at a SEPP router for routing messages between PLMNs. The steps include registering a first roaming hub SEPP. Registering the first roaming hub SEPP includes receiving an NFRegister request from the first roaming hub SEPP, the NFRegister request including an NF profile of the first roaming hub SEPP; and storing at least a portion of the NF profile of the first roaming hub SEPP. The steps further include receiving an SBI request message from a second roaming hub SEPP; determining, a PLMN as an intended destination for the SBI request message; and routing the SBI request message to the first roaming hub SEPP based on the stored at least a portion of the NF profile of the first roaming hub SEPP and the determination of the PLMN as the intended destination for the SBI request message.

According to another aspect of the subject matter described herein, the executable instructions may further include receiving, at the SEPP router, a plurality of SBI request messages from a plurality of roaming hub SEPPs; and filtering, using a security database in the SEPP router, the plurality of SBI request messages.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Exemplary implementations of the subject matter described herein will now be explained with reference to the accompanying drawings, of which:

FIG. 1 is a network diagram illustrating an exemplary 5G system network architecture;

FIG. 2 is a block diagram illustrating a system including roaming hub with roaming hub SEPPs to route messages between different networks;

FIG. 3A is a block diagram illustrating a system including roaming hub with roaming hub SEPPs and an SEPP router to route messages between different networks;

FIG. 3B is a message flow diagram illustrating exemplary messages exchanged in registering an SEPP instance with an SEPP router and using information obtained from the registration to route an SBI request between SEPPs;

FIG. 4 is a block diagram illustrating an SEPP router;

FIG. 5 is a block diagram illustrating a system including SEPP router to route messages between SEPPs of PLMNs; and

FIG. 6 is a message flow diagram illustrating an exemplary method for providing an SEPP router for routing between roaming hub SEPPs.

### DETAILED DESCRIPTION

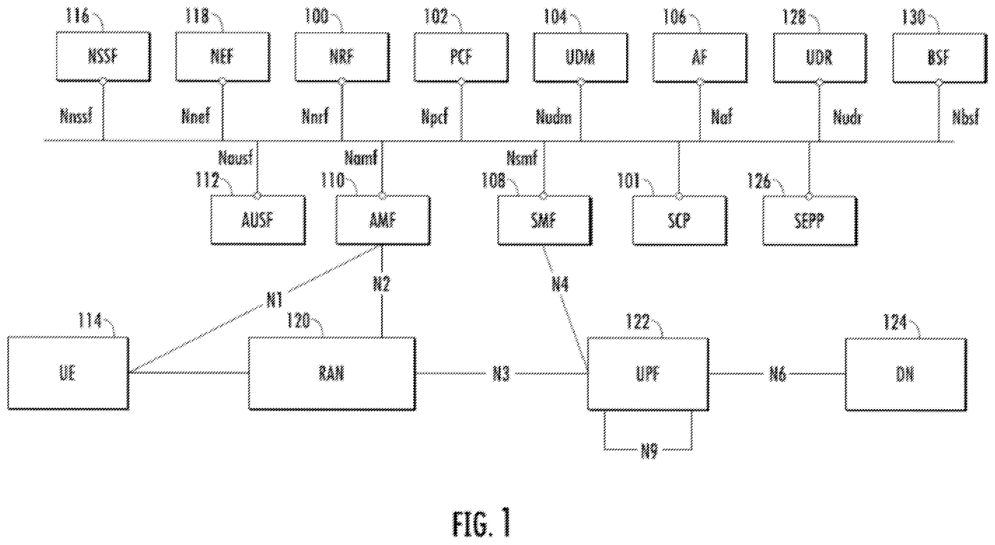

FIG. 1 is a network diagram illustrating an exemplary 5G system network architecture. The architecture in FIG. 1 includes NRF 100 and SCP 101, which may be located in the same home public land mobile network (HPLMN). As described above, NRF 100 may maintain profiles of available NF instances and their supported services and allow consumer NFs or SCPs to subscribe to and be notified of the registration of new/updated NF instances. SCP 101 may also support service discovery and selection of NF instances. SCP 101 may perform load balancing of connections between consumer and producer NFs.

NRF 100 is a repository for profiles of NF instances. In order to communicate with a producer NF instance, a consumer NF or an SCP must obtain the NF profile of the producer NF instance from NRF 100. The NF profile is a JavaScript object notation (JSON) data structure defined in 3GPP TS 29.510. The NF profile includes attributes that indicate the type of service provided, capacity of the NF instance, and information for contacting the NF instance.

In FIG. 1, any of the network functions can be consumer NFs, producer NFs, or both, depending on whether they are requesting, providing, or requesting and providing services. In the illustrated example, the NFs include a policy control function (PCF) 102 that performs policy related operations in a network, a unified data management function (UDM) 104 that manages user data, and an application function (AF) 106 that provides application services.

The NFs illustrated in FIG. 1 further include a session management function (SMF) 108 that manages sessions between an access and mobility management function (AMF) 110 and PCF 102. AMF 110 performs mobility management operations similar to those performed by a mobility management entity (MME) in 4G networks. An authentication server function (AUSF) 112 performs authentication services for user equipment (UEs), such as user equipment (UE) 114, seeking access to the network.

A network slice selection function (NSSF) 116 provides network slicing services for devices seeking to access specific network capabilities and characteristics associated with a network slice. NSSF 116 provides the NSSelection service, which allows NFs to request information about network slices and the NSSAIAvailability service, which enables NFs to update and subscribe to receive notification of updates in network slice selection assistance information (NSSAI) availability information.

A network exposure function (NEF) 118 provides application programming interfaces (APIs) for application functions seeking to obtain information about Internet of things (IOT) devices and other UEs attached to the network. NEF 118 performs similar functions to the service capability exposure function (SCEF) in 4G networks.

A radio access network (RAN) 120 connects user equipment (UE) 114 to the network via a wireless link. Radio access network 120 may be accessed using a gNB (not shown in FIG. 1) or other wireless access point. A user plane function (UPF) 122 can support various proxy functionality for user plane services. One example of such proxy functionality is multipath transmission control protocol (MPTCP) proxy functionality. UPF 122 may also support performance measurement functionality, which may be used by UE 114 to obtain network performance measurements. Also illustrated in FIG. 1 is a data network (DN) 124 through which UEs access data network services, such as Internet services.

SEPP 126 filters incoming traffic from another PLMN and performs topology hiding for traffic exiting the home PLMN. Each PLMN may include one or more SEPPs 126. SEPP 126 may communicate with an SEPP in a foreign PLMN which manages security for the foreign PLMN. Thus, traffic between NFs in different PLMNs may traverse two SEPP functions, one for the home PLMN and the other for the foreign PLMN.

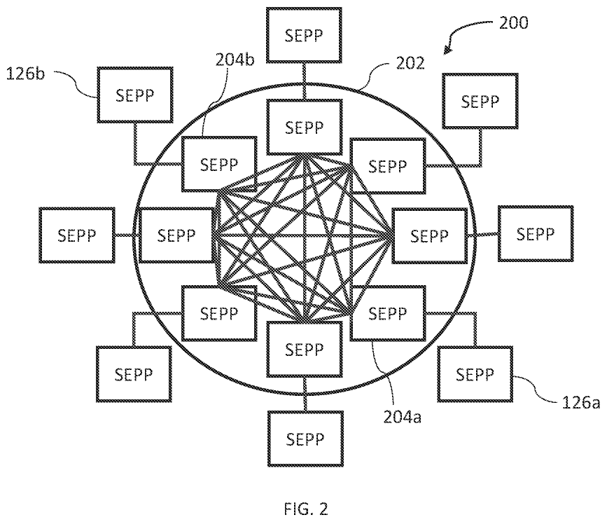

FIG. 2 is a block diagram of a system 200 using a roaming hub 202 with roaming hub SEPPs 204 that are communicatively connected to SEPPs 126 of PLMNs. A roaming hub is a centralized service that manages roaming agreements between mobile operators of PLMNs and provides users roaming services from PLMNs with simplified roaming agreements, such as a single roaming agreement. A roaming hub, therefore, can be used to manage roaming services from a multitude of PLMNs. Roaming hub SEPPs 204 are SEPPs implemented within a roaming hub, such as roaming hub 202, to communicatively connect SEPPs 126 of different PLMNs. Roaming hub 202 may include a mesh architecture by which each roaming hub SEPP 204 is communicatively connected to all other roaming hub SEPPs 204 and configured to send and/or receive communications from other roaming hub SEPPs 204. Roaming hub 202 connects one Mobile Network Operator (MNO) in a first Public Land Mobile Network (PLMN) to another MNO in a second PLMN, thereby providing one or more channels for inter-PLMN communication. Roaming hub 202 may connect any number of PLMNs. Each PLMN may include one or more SEPPs 126 to communicate with SEPPs 126 of other PLMNs via roaming hub 202. Specifically, SEPP 126a of a first PLMN may, acting as a consumer SEPP, send a service-based interface (SBI) request message to roaming hub 202 to be delivered to SEPP 126b of a second PLMN. A first roaming hub SEPP 204a, also acting as a consumer SEPP, may receive the SBI request message from SEPP 126a and forward the SBI request message to SEPP 204b, acting as a producer SEPP, which then delivers the message to SEPP 126b of the second PLMN, which is also acting as a producer SEPP in this example.

Additional roaming hub SEPPs 204 are needed as inter-PLMN communication increases. Additional roaming hub SEPPs 204 may also be required due to other reasons, such as security measures. However, one problem in 5G networks due to the mesh architecture among roaming hub SEPPs 204 is that the roaming hub SEPPs 204 are required to implement complex routing features, which further increase in complexity as the amount of roaming hub SEPPs 204 deployed by the roaming hub 202 increases.

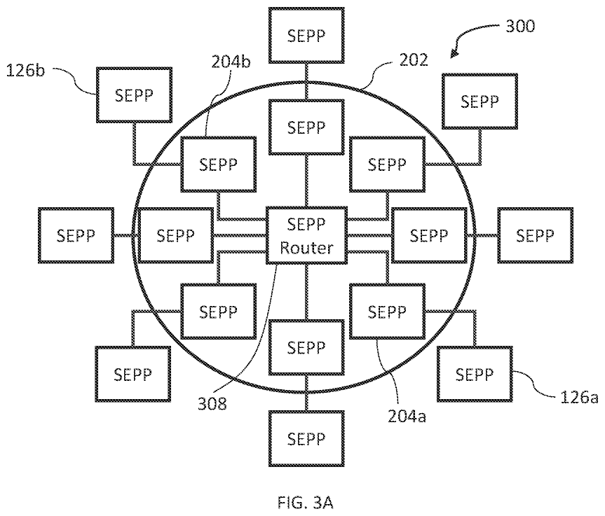

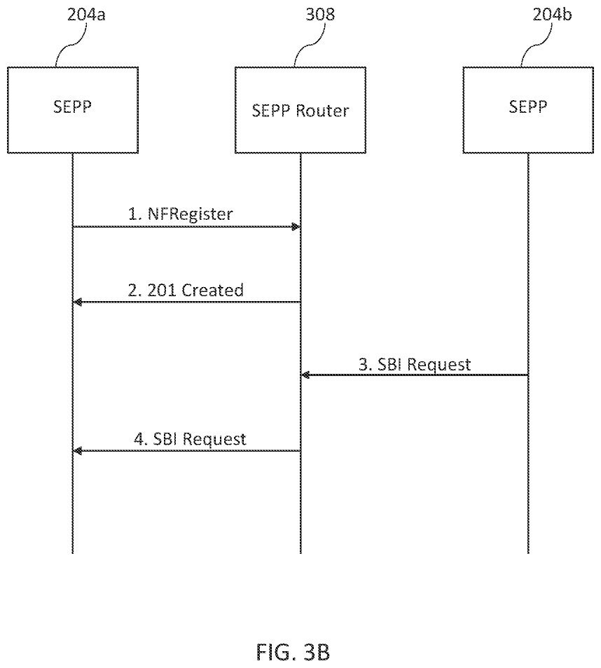

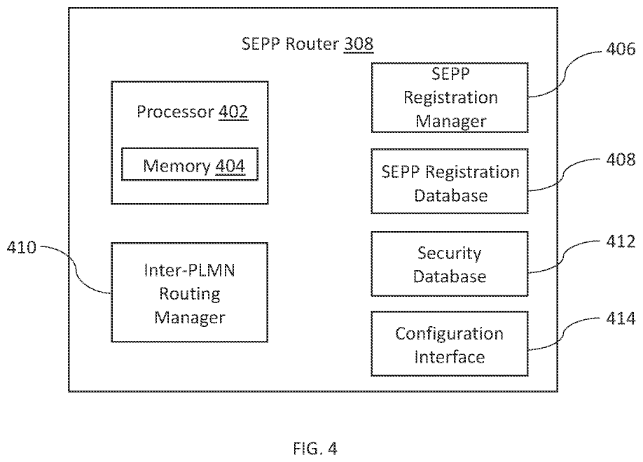

FIG. 3A is a diagram of a system 300 for routing messages, such as SBI request messages, among PLMNs. Similar to system 200 shown in FIG. 2, system 300 includes a roaming hub 202 with roaming hub SEPPs 204 that are communicatively connected to SEPPs 126 of PLMNs. Unlike system 200, system 300 includes an SEPP router 308, as detailed in FIG. 4, that communicatively connects roaming hub SEPPs 204. As described in this disclosure, SEPP router 308 is configured for implementing an NFRegister interface through which SEPPs, such as roaming hub SEPPs 204, can register their SEPP profiles. From the SEPP profiles, SEPP router 308 can build an SEPP registration database, such as SEPP registration database 408 shown in FIG. 4, which includes SEPP routing information for routing messages between the roaming hub SEPPs 204. An exemplary advantage to this configuration is that the roaming hub SEPPs 204 can offload complex routing rules to SEPP router 308. Another advantage is that, with SEPP router 308, roaming hub SEPPs 204 no longer need to have a mesh architecture, which frees the roaming hub 202 to add roaming hub SEPPs 204 without limitation. System 300 may include a SEPP router interface through which SEPP router 308 and roaming hub SEPPs 204 communicate. SEPP router interface may include an NRF registration interface.

One advantage of implementing an NFRegister interface at SEPP router 308 is that SEPPs can register their SEPP profiles with SEPP router 308 using the same messaging and functionality that SEPPs register with the NRF. FIG. 3B is a message flow diagram illustrating exemplary messages exchanged in using an NFRegister interface at SEPP router 308 and using information from the registered SEPP profiles to route messages between SEPPs. Referring to FIG. 3B, in line 1, SEPP 204a sends an NFRegister request to SEPP router 308. The NFRegister request may be formatted as specified in Section 5.2.2.2 of 3GPP TS 29.510 and may include the NF profile of SEPP 204a. SEPP router 308 receives the NFRegister request, validates the request and stores some or all of the NF profile of SEPP 204a in an SEPP registration database. In one example, SEPP router 308 may store the entire NF profile of SEPP 204a in its SEPP registration database. In another example, SEPP router 308 may store NF profile attributes that can be used for inter-PLMN message routing and/or security without storing the entire SEPP profile. Examples of SEPP profile attributes that can be used for routing and/or security include the NFInstanceId, NFType, nfStatus, plmnList, sNssais, fqdn, IPv4Addresses, IPv6Addresses, allowedPlmns, etc. A list of NF profile attributes and their associated descriptions can be found in Table 6.1.6.2.2-1 of 3GPP TS 29.510.

In line 2 of the message flow diagram, SEPP router 308 responds to the NFRegister request with a 201 Created message confirming successful registration of the NF profile. In line 3 of the message flow diagram SEPP 204b sends a service-based interface (SBI) request to SEPP router 308. The SBI request may be a request originating from an NF in the PLMN protected by SEPP 204b requesting a service from a producer NF in the PLMN protected by SEPP 204a. SEPP router 308 uses one or more parameters from the SBI request to perform a lookup in its SEPP registration database to identify a next-hop SEPP to which the SBI request should be forwarded. For example, SEPP router 300 may utilize a PLMN Id from the SBI request to perform a lookup in the SEPP registration database and determine that the SBI request should be routed to the PLMN protected by SEPP 204a. In line 3, SEPP router 300 routes the SBI request to SEPP 204a.

SEPP router 308 may apply one or more security measures to the SBI request prior to or instead of routing the message to SEPP 204a. For example, SEPP router 308 may determine whether the source PLMN of the SBI request is allowed to send messages to the PLMN of SEPP 204a. If the source PLMN is allowed to send messages to the PLMN of SEPP 204a, SEPP router 308 may route the message to SEPP 204a. If the source PLMN is not allowed to send messages to the PLMN of SEPP 204a, SEPP router 308 may block the message, thereby implementing a firewalling function.

In some embodiments, SEPP router 308 is configured to provide and/or enforce routing policies for messages between PLMN SEPPs 126 and roaming hub SEPPs 204 and messages among roaming hub SEPPs 204. Routing policies may include load balancing, traffic prioritization, routing control, mediation, canary upgrading, alternate routing, congestion control, circuit breaking, outlier detection, and/or the like. Roaming hub SEPPs 204 and SEPP router 308 may be configured to communicate with one another to implement the routing policies. For example, roaming hub SEPPs 204 may send information to SEPP router 308 such as current load, current capacity, and availability. Roaming hub SEPPs 204 may publish capacity information to SEPP router 308 as part of registration or updates for the roaming hub SEPPs 204. Roaming hub SEPPs 204 may publish load information to SEPP router 308 as part of updates for the roaming hub SEPPs 204. In some embodiments, SEPP router 308 may establish that roaming hub SEPPs 204 publish information such as capacity information and/or load information at a given recurring time interval. SEPP router 308 may set traffic rules for roaming hub SEPPs 204 based on the information received from the roaming hub SEPPs 204.

Load balancing among roaming hub SEPPs 204 by SEPP router 308 may be based on capacity information and/or load information received from one or more roaming hub SEPPs 204. In some embodiments, SEPP router 308 can support technology such as round robin, weighted round robin, transaction latency, and other appropriate load balancing based on current load and availability of roaming hub SEPPs 204. SEPP router 308 may implement a traffic prioritization policy, wherein the SEPP router 308 sheds lower priority network traffic in response to detecting an overload condition according to the policy. In some embodiments, SEPP router 308 may be configured to implement canary releases or canary upgrades. For example, SEPP router 308 may upgrade features such as services provided by some of the roaming hub SEPPs 204, while not upgrading the remaining roaming hub SEPPs 204. In some embodiments, SEPP router 308 may adjust a routing policy based on a canary policy such as reducing traffic to upgraded roaming hub SEPPs 204 or restricting the availability of upgraded roaming hub SEPPs 204 to select PLMN SEPPs 126 to create a smaller test environment.

SEPP router 308 may provide an alternate route for a message, such as an SBI request message, when notified of an upstream issue, for example, a timeout error, a server not found, a permanent/temporary redirect notice, a requested timeout, determining an outlier roaming hub SEPP 204, or the like. SEPP router 308 may passively detect that producer roaming hub SEPP 204 is an outlier if the SEPP router 308 receives a specified amount of consecutive errors from the producer roaming hub SEPP 204. An alternate route may include using an alternate producer roaming hub SEPP 204. Routing policies may include circuit breaking, wherein SEPP router 308 suspends sending messages to a producer roaming hub SEPP 204 that has reached a threshold amount of outstanding transactions. Routing policies may also include congestion control policies based on, for example, token counting to reduce traffic flow when congestion is identified.

FIG. 4 is a block diagram of SEPP router 308. SEPP router 308 includes at least one processor 402 for routing messages among a plurality of roaming hub SEPPs 204. Processor 402 may include one or more processors, such as a central processing unit (e.g., a single core or multiple processing cores), a microprocessor, a microcontroller, a network processor, an application-specific integrated circuit (ASIC), or the like. SEPP router 308 may also include memory 404. Memory 404 may comprise random access memory (RAM), flash memory, a magnetic disk storage drive, and the like.

SEPP router 308 can include an SEPP registration manager 406 implemented by at least one processor 402 for registering one or more roaming hub SEPPs of the plurality of roaming hub SEPPs 204 such as first roaming hub SEPP 204a shown in FIG. 3. As an example, registering first roaming hub SEPP 204a includes receiving, at SEPP router 308, an NFRegsiter request from first roaming hub SEPP 204a. SEPP router 308 then stores at least a portion of the NF profile of first roaming hub SEPP 204a. The NF profile can include an indication of the location of first roaming hub SEPP 204a and the one or more services supported by the first roaming hub SEPP 204a. In some embodiments, SEPP router 308 may store the at least a portion of the NF profile in SEPP registration database 408 at the SEPP router 308. In some embodiments, SEPP registration database 408 may be remote to SEPP router 308 and the SEPP router 308 may have access to retrieve the stored SEPP profiles.

In some embodiments, roaming hub SEPPs 204 may register with SEPP router 308 when the roaming hub SEPPs 204 and their corresponding services become operational. In some embodiments, a consumer SEPP, such as first roaming hub SEPP 204a in this example, may send to SEPP router 308 an SBI request message with the accompanying NFRegister request if the first roaming hub SEPP 204a has not yet registered with SEPP router 308. SEPP router 308 may be configured for receiving a discovery request from roaming hub SEPP 204 to obtain information about other roaming hub SEPPs 204, which may include parameters such as a type of service. SEPP router 308 may respond to the discovery request by sharing the identity and/or location of one or more roaming hub SEPPs 204 that provide the service identified in the requests.

In some embodiments, a Uniform Resource Identifier (URI) may represent roaming hub SEPP 204. Roaming hub SEPP 204 may determine the URI. Roaming hub SEPP 204 may register with SEPP router 308 by sending to the URI a PUT request with a payload body including a representation of the roaming hub SEPP 204 to be registered. SEPP router 308 may send a PUT response confirming the registration once registration is complete. SEPP router 308 may be configured for sending notifications of topology changes, such as sending a notification when a new SEPP has been registered.

SEPP router 308 further includes an inter-PLMN routing manager 410 implemented by at least one processor 402 for receiving SBI request messages from one or more roaming hub SEPPs 204, such as an SBI request message from second roaming hub SEPP 204b shown in FIG. 3. SEPP router 308 may be configured for prioritizing traffic among a plurality of SBI request messages received from various roaming hub SEPPs 204 as described in this disclosure.

According to another aspect of the subject matter described herein, SEPP router 308 is configured for receiving a plurality of SBI request messages from a plurality of roaming hub SEPPs 204. SEPP router 308 may filter the plurality of SBI request messages using a security database 412 in the SEPP router 308. SEPP router 308 may filter SBI request messages based on source and destination addresses of the messages, ports, or protocols. In some embodiments, security database 412 may include a list of dangerous or quarantined addresses. SEPP router 308 may check the addresses in security database 412 after receiving an SBI request message and drop the message if the source or destination address matches a listed address.

In some embodiments, SEPP router 308 may include an inter-PLMN routing manager 410. Inter-PLMN routing manager 410 is configured for determining, by SEPP router 308 and using the stored at least a portion of the NF profile of the first SEPP, a PLMN of the first SEPP as an intended destination for the SBI request message. Inter-PLMN routing manager 410 may identify the PLMN as the intended destination based on contents of the SBI request message. Inter-PLMN routing manager 410 then routes, by SEPP router 308, the SBI request message to a selected roaming hub SEPP 204, such as first roaming hub SEPP 204a.

In some embodiments, SEPP router 308 may be configured for receiving, at a configuration interface 414 of the SEPP router 308, user input for registering roaming hub SEPPs 204. Configuration interface 414 may receive information contained in an NFRegister request, such as at least a portion of an NF profile of a roaming hub SEPP 204, manually from a user and store the at least a portion of the NF profile in the SEPP registration database 408.

The SEPP router may be configured for applying a security measure to the SBI request message. In some embodiments, the security measure applied includes network topology hiding, such as hiding topology-related information in SBI request messages sent from a trusted network to an untrusted network. In some embodiments, SEPP router 308 is configured for verifying registration of an NF profile for second roaming hub SEPP of the second roaming hub SEPP 204b. SEPP router 308 may include a policy to verify registration of any roaming hub SEPP 204 from which it receives an SBI request message. In some embodiments, SEPP router 308 may be configured to receive a command to verify registration of one or more NF profiles of roaming hub SEPPs 204.

First roaming hub SEPP 204a, acting as a producer NF in this example, may then forward the SBI request message to an SEPP of the destination PLMN, such as SEPP 126a. SEPP router 308 may include an inter-PLMN (N32) interface by which PLMN SEPPs 126 and roaming hub SEPPs 204 communicate. A detailed description of the N32 interface is in 3GPP TS 29.510, which is incorporated herein by reference in its entirety.

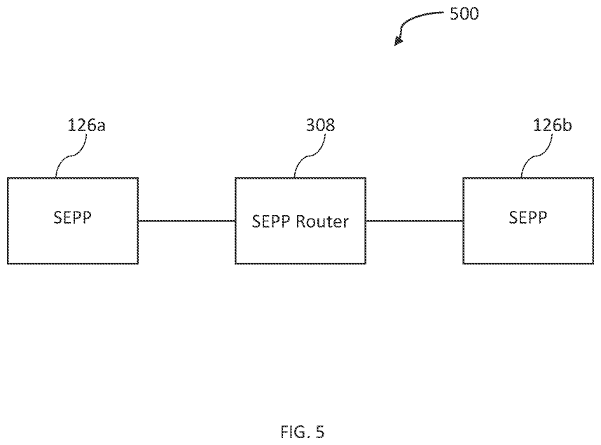

In some embodiments, SEPP router 308 operates without roaming hub 202 or roaming hub SEPPs 204, wherein the SEPP router 308 routes messages between SEPPs 126 of PLMNs, such as in system 500 illustrated in FIG. 5. Accordingly, SEPP router 308 can register SEPPs 126, store at least portions of NF profiles of SEPPs 126, and receive and route SBI messages from and to SEPPs 126 in the same manner the SEPP router 308 does for SEPPs 204 as described in this disclosure. For example, SEPP registration manager 406 may register a first SEPP 126a of a first PLMN by receiving, at SEPP router 308, an NFRegister request from first SEPP 126a including an NF profile of first SEPP 126a, and storing, by the SEPP router 308, at least a portion of the NF profile of first SEPP 126a. SEPP router 308 may store the at least a portion of the NF profile in SEPP registration database 408. Inter-PLMN routing manager 410 may receive an SBI request message from a second SEPP 126b of a second PLMN and determine, by SEPP router 308 and using the stored at least a portion of NF profile of first SEPP 126a, a PLMN of the first SEPP 126a as an intended destination for the SBI request message. SEPP router 308 may then route the SBI request message to first SEPP 126a.

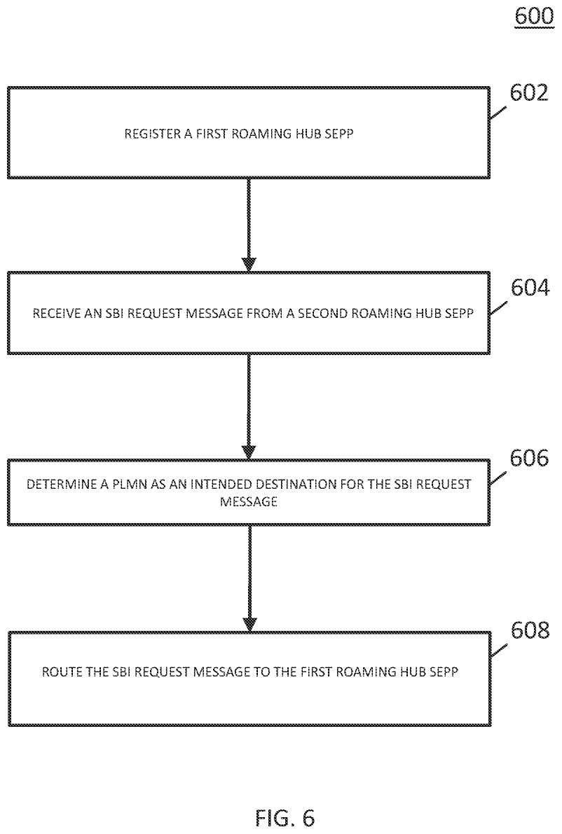

FIG. 6 is a flow diagram illustrating an exemplary method 600 for providing an SEPP router for routing between SEPPs connected to PLMNs. In step 602, the SEPP router registers a first roaming hub SEPP. Registering the first roaming hub SEPP includes receiving, at the SEPP router, an NFRegister request from the first roaming hub SEPP. The NFRegister request includes an NF profile of the first roaming SEPP. This step further includes the SEPP router storing at least a portion of the NF profile of the first roaming hub SEPP. The NF profile may include an indication of the location of the first roaming hub SEPP and the one or more services supported by the first roaming hub SEPP. In some embodiments, the SEPP router may include configuration interface 414 by which a user may manually input at least a portion of an NF profile of roaming hub SEPP to register the roaming hub SEPP.

At step 604, the SEPP router receives an SBI request message from a second roaming hub SEPP. The SEPP router may verify registration of an NF profile of the second roaming hub SEPP.

At step 606, the SEPP router determines a PLMN as an intended destination for the SBI request message. The SEPP router may use the at least a portion of the NF profile of the first roaming hub to make the determination.

At step 608, the SEPP router routes the SBI request message to the first roaming hub SEPP. The SEPP router routes the SBI request to the first roaming hub SEPP based on the stored at least a portion of the NF profile of the first roaming hub SEPP and the determination of the PLMN as the intended destination for the SBI request message. The SEPP router may include inter-PLMN routing manager 410 to implement the routing of messages, such as the SBI request message. The first roaming hub SEPP may then forward the SBI request message to an SEPP of the destination PLMN, such as a PLMN SEPP. The SEPP router may include complex routing features such as, for example, prioritizing traffic of a plurality of SBI request messages received from roaming hub SEPPs.

The disclosure of each of the following references is hereby incorporated herein by reference in its entirety.

### REFERENCES

1. 3^{rd} Generation Partnership Project; Technical Specification Group Core Network and Terminals; 5G System; Network Function Repository Services; Stage 3 (Release 17) 3GPP TS 29.510 V17.6.0 (2022 June)

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for providing a security edge protection proxy (SEPP) router for routing messages between roaming hub SEPPs, the method comprising:
registering, at an SEPP router, a first roaming hub SEPP, the registering comprising:
receiving, at the SEPP router, an NFRegister request from the first roaming hub SEPP, the NFRegister request including an NF profile of the first roaming hub SEPP; and
storing, by the SEPP router, at least a portion of the NF profile of the first roaming hub SEPP;
receiving, at the SEPP router, a service-based interface (SBI) request message from a second roaming hub SEPP;
determining, by the SEPP router, a public land mobile network (PLMN) as an intended destination for the SBI request message; and
routing, by the SEPP router, the SBI request message to the first roaming hub SEPP based on the stored at least a portion of the NF profile of the first roaming hub SEPP and the determination of the PLMN as the intended destination for the SBI request message.

2. The method of claim 1 comprising implementing an NFRegister interface at the SEPP router, wherein registering the first roaming hub SEPP includes receiving and processing the NFRegister request via the NFRegister interface implemented at the SEPP router.

3. The method of claim 1 wherein storing the at least a portion of the NF profile includes storing the at least a portion of the NF profile in an SEPP registration database at the SEPP router.

4. The method of claim 1 comprising:
receiving, at the SEPP router, a plurality of SBI request messages from a plurality of roaming hub SEPPs; and
filtering, using a security database in the SEPP router, the plurality of SBI request messages.

5. The method of claim 1 comprising prioritizing, by the SEPP router, traffic among roaming hub SEPPs.

6. The method of claim 1 comprising receiving, at a configuration interface of the SEPP router, user input for registering roaming hub SEPPs.

7. The method of claim 1 comprising performing, by the SEPP router, load balancing among roaming hub SEPPs.

8. The method of claim 1 comprising applying network topology hiding to the SBI request message.

9. The method of claim 1 comprising verifying, by the SEPP router, registration of an NF profile of the second roaming hub SEPP.

10. A system for routing messages between roaming hub security edge protection proxies (SEPPs), the system comprising:
an SEPP router including at least one processor for routing messages among roaming hub SEPPs;
an SEPP registration manager implemented by the at least one processor for registering, at the SEPP router, a first roaming hub SEPP, the registering comprising:
receiving, at the SEPP router, an NFRegister request from the first roaming hub SEPP, the NFRegister request including an NF profile of the first roaming hub SEPP; and
storing, by the SEPP router, at least a portion of the NF profile of the first roaming hub SEPP; and
an inter-public land mobile network (PLMN) routing manager implemented by the at least one processor for receiving a service-based interface (SBI) request message from a second roaming hub SEPP, determining, by the SEPP router, a PLMN as an intended destination for the SBI request message, and routing, by the SEPP router, the SBI request message to the first roaming hub SEPP based on the stored at least a portion of the NF profile of the first roaming hub SEPP and the determination of the PLMN as the intended destination for the SBI request message.

11. The system of claim 10 further including an NFRegister interface implemented by the at least one processor at the SEPP router, wherein registering the first roaming hub SEPP includes receiving and processing the NFRegister request via the NFRegister interface implemented at the SEPP router.

12. The system of claim 10, wherein storing the at least a portion of the NF profile includes storing the at least a portion of the NF profile in an SEPP registration database at the SEPP router.

13. The system of claim 10, wherein the SEPP router is configured for:
receiving a plurality of SBI request messages from a plurality of roaming hub SEPPs; and
filtering, using a security database in the SEPP router, the plurality of SBI request messages.

14. The system of claim 10, wherein the SEPP router is configured for prioritizing traffic among roaming hub SEPPs.

15. The system of claim 10, wherein the SEPP router is configured for receiving, at a configuration interface of the SEPP router, user input for registering roaming hub SEPPs.

16. The system of claim 10, wherein the SEPP router is configured for performing load balancing among roaming hub SEPPs.

17. The system of claim 10, wherein the SEPP router is configured for applying network topology hiding to the SBI request message.

18. The system of claim 10, wherein the SEPP router is configured for verifying registration of an NF profile of the second roaming hub SEPP.

19. A non-transitory computer readable medium having stored thereon executable instructions that when executed by at least one processor of at least one computer cause the at least one computer to perform steps comprising:
at a security edge protection proxy (SEPP) router for routing messages between public land mobile networks (PLMNs):
registering a first roaming hub SEPP, the registering comprising:
receiving an NFRegister request from the first roaming hub SEPP, the NFRegister request including an NF profile of the first roaming hub SEPP; and
storing at least a portion of the NF profile of the first roaming hub SEPP;
receiving a service-based interface (SBI) request message from a second roaming hub SEPP;
determining a PLMN as an intended destination for the SBI request message; and
routing the SBI request message to the first roaming hub SEPP based on the stored at least a portion of the NF profile of the first roaming hub SEPP and the determination of the PLMN as the intended destination for the SBI request message.

20. The non-transitory computer readable medium of claim 19 wherein the executable instructions further include:
receiving, at the SEPP router, a plurality of SBI request messages from a plurality of roaming hub SEPPs; and
filtering, using a security database in the SEPP router, the plurality of SBI request messages.
